(19) United States
(12) Patent Application Publication
(10) Pub. No.: US 2005/0024630 A1
(43) Pub. Date: Feb. 3, 2005

(54) Device for examining end part

(75) Inventors: Toshiki Ohno, Hyogo (JP); Hirotoshi Ise, Hyogo (JP); Masato Toyota, Hyogo (JP); Toshio Komemura, Hyogo (JP); Hidefumi Sakita, Hyogo (JP); Suekazu Nakashima, Hyogo (JP); Koji Matsuda, Hyogo (JP)

Correspondence Address: McDermott, Will & Emery, 600 13th Street, N.W., Washington, DC, 20005-3096, US

(73) Assignees: Renesas Technology Corp.; Renesas Device Design Corp.

(21) Appl. No.: 10/833,038

(22) Filed: Apr. 28, 2004

(30) Foreign Application Priority Data
Apr. 28, 2003 (JP) 2003-123885(P)

(51) Int. Cl. G01N 21/88

(52) U.S. Cl. 356/237.1

(57) ABSTRACT

A device for examining an end part according to the present invention includes a light projecting portion, a light receiving portion, a displacement sensor amplifier, and a data processing apparatus. The light projecting portion projects light on the end part of a semiconductor wafer. The light receiving portion receives specular reflected light reflected from the end part of the semiconductor wafer. The displacement sensor amplifier and the data processing apparatus calculate the displacement amount of the end part of the semiconductor wafer by a change in the distribution of the quantity of the specular reflected light received by the light receiving portion. Thus, the device for examining an end part can be reduced in size and simplified. Additionally, the device for examining an end part can be obtained, with which a change of the material of the end part of a measurement target is hardly detected as defects falsely.

### BACKGROUND OF THE INVENTION

1. Field of the Invention

The present invention relates to a device for examining an end part, and specifically, to a device for examining an end part that projects light on the end part of a measurement target, and detects a defect in the end part of the measurement target by the reflected light therefrom.

2. Description of the Background Art

In the manufacturing process of a semiconductor apparatus, a semiconductor wafer undergoes numerous transportations and processes by a semiconductor manufacturing apparatus. In such transportations and processes by a semiconductor manufacturing apparatus, a defect such as a chip or a scratch may occur in the end part of the semiconductor wafer due to, for example, a mechanical failure of a transportation apparatus. The semiconductor wafer with such a defect easily fractures under mechanical stress produced during the transportation or thermal stress produced from a heat treatment during processes. Furthermore, a piece of the fractured semiconductor wafer may remain in the semiconductor manufacturing apparatus to cause errors in a process, or it may adhere to a normal wafer as a foreign object to reduce the yield of the manufactured semiconductor wafers.

In order to avoid such a problem, it is necessary to examine the end part of the semiconductor wafer. A conventional device for examining an end part of a semiconductor wafer is disclosed, for example, in Japanese Patent Laying-Open No. 11-351850.

The device for examining an end part of a semiconductor wafer disclosed in the above-mentioned publication mainly includes a rotating table for retaining a wafer, a light projecting portion, two detectors, and an ellipsoidal mirror. The end part of a wafer is arranged at a first focus of the ellipsoidal mirror, and one of the detectors is arranged immediately above or immediately below the end part of the wafer. The other detector is arranged at a second focus of the ellipsoidal mirror.

When a scratch (a chip) exists in the end part of the wafer, the light projected from the light projecting portion is scattered at the end part of the wafer. Here, when the scratch extends horizontally, scattering reflected light is produced substantially vertically, which is received by one detector. When the scratch extends vertically, scattering reflected light is produced substantially horizontally, which is reflected by the ellipsoidal mirror and received by the other detector. The quantity of the scattering reflected light detected by the one detector, and that detected by the other detector are each converted into digital signals through electric circuitry. Thus, based on the quantity and direction of each generated scattering reflected light, the presence and the shape of a scratch in the end part of the wafer are evaluated. It is noted that a similar device for examining an end part of a semiconductor wafer is disclosed in Japanese Patent Laying-Open No. 9-269298.

However, according to the above-discussed conventional device for examining an end part of a semiconductor wafer, since presence of a defect in the end part of a wafer is evaluated based on the quantity and direction of each scattering reflected light, the configuration having the ellipsoidal mirror for reflecting the scattering reflected light toward the light receiving portion, a plurality of light receiving portions and the like is required. Accordingly, the number of the components thereof is great, which disadvantageously increases the device for examining an end part in size, and complicates it.

Additionally, in some manufacturing processes of a semiconductor apparatus, a thin film or a photoresist may be formed in the end part of a semiconductor wafer. With a change of the material of the end part of the semiconductor wafer, the quantity and direction of scattering reflected light largely change. Hence, there has been a problem that such a thin film or a photoresist is falsely detected as a defect.

### SUMMARY OF THE INVENTION

An object of the present invention is to provide a device for examining an end part which can be reduced in size and simplified, and with which a change of the material of the end part of a measurement target is hardly detected as defects falsely.

A device for examining an end part according to the present invention includes: a light projecting portion projecting light on an end part of a measurement target; a light receiving portion receiving specular reflected light reflected from the measurement target; and a calculating apparatus. The calculating apparatus is for calculating a displacement amount of the end part of the measurement target based on a change in a distribution of a quantity of the specular reflected light received by the light receiving portion.

In the device for examining an end part according to the present invention, a displacement amount of the end part of the measurement target is calculated based on a change in a distribution of a quantity of the specular reflected light received by the light receiving portion. Accordingly, the configuration for receiving light requires only one light receiving portion and does not require a configuration such as an ellipsoidal mirror. Additionally, a plurality of light receiving portions are not necessary. Therefore, the device for examining an end part can be reduced in size and simplified.

With a change of the material of the end part of the measurement target, the distribution of the quantity of received specular reflected light changes only slightly as compared to scattering reflected light. Accordingly, the change of the material of the end part of the measurement target is hardly detected as a defect falsely.

In the present specification, “specular reflected light” refers to light reflected in a constant direction with an angle of reflection that is equal to an angle of incidence at projection, and it refers to light that is different from scattering reflected light.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic illustration showing a configuration of a device for examining an end part according to a first embodiment of the present invention.

FIG. 2 is an enlarged view of a substantial part of the device for examining an end part according to the first embodiment of the present invention.

FIG. 3 shows an example of a relationship between a relative distance calculated by a displacement sensor amplifier and a position.

FIG. 4 shows one example of a calculation process flow executed by a data processing apparatus according to the first embodiment of the present invention.

FIG. 5 shows an example of a relationship between a displacement amount calculated by the data processing apparatus and a position.

FIG. 6 is a schematic illustration showing a partial configuration of a device for examining an end part according to a second embodiment of the present invention.

FIG. 7 shows an example of a relationship between a relative distance calculated by a displacement sensor amplifier and a position where a slit is not included.

FIG. 8 shows an example of a relationship between a relative distance calculated by a displacement sensor amplifier and a position where a slit is included.

FIG. 9 is a schematic illustration showing a partial configuration of a device for examining an end part according to a third embodiment of the present invention.

FIG. 10 is a schematic illustration showing a defect formed in the upper portion of an end part of a semiconductor wafer.

FIG. 11 is a schematic illustration showing another partial configuration of a device for examining an end part according to the third embodiment of the present invention.

### DESCRIPTION OF THE PREFERRED EMBODIMENTS

In the following, embodiments of the present invention will be described referring to the drawings.

### First Embodiment

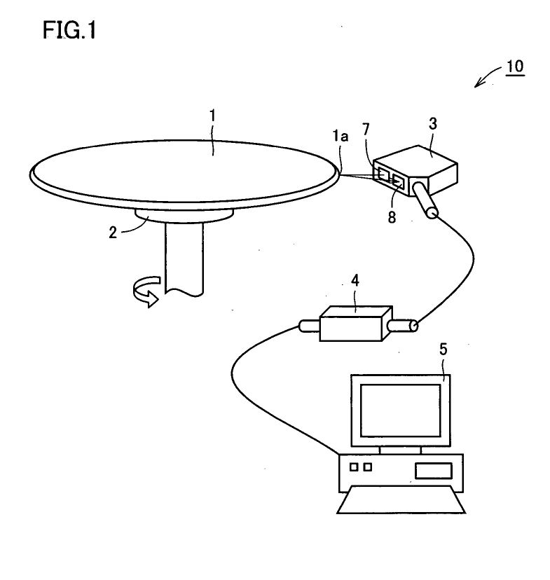

Referring to FIG. 1, a device for examining an end part 10 according to the present embodiment includes a retaining/rotating table 2, an optical displacement sensor 3, a displacement sensor amplifier 4 (a calculating apparatus), and a data processing apparatus 5 (a calculating apparatus). Retaining/rotating table 2 retains a semiconductor wafer 1 (a measurement target) by suction at a lower main surface of semiconductor wafer 1. By the rotation of retaining/rotating table 2, semiconductor wafer 1 rotates. Optical displacement sensor 3 is arranged in the vicinity of semiconductor wafer 1 and is arranged in a direction horizontal to the main surface of semiconductor wafer 1. Optical displacement sensor 3 has a light projecting portion 7 and a light receiving portion 8. Optical displacement sensor 3 and displacement sensor amplifier 4 are electrically connected to each other, while displacement sensor amplifier 4 and data processing apparatus 5 are electrically connected to each other. Light projecting portion 7 is structured, for example, with a visible light semiconductor laser, a light emitting diode or the like. Light receiving portion 8 is structured, for example, with a CCD (Charge Coupled Device) or the like.

Next, the operation of device for examining an end part 10 according to the present embodiment will be described.

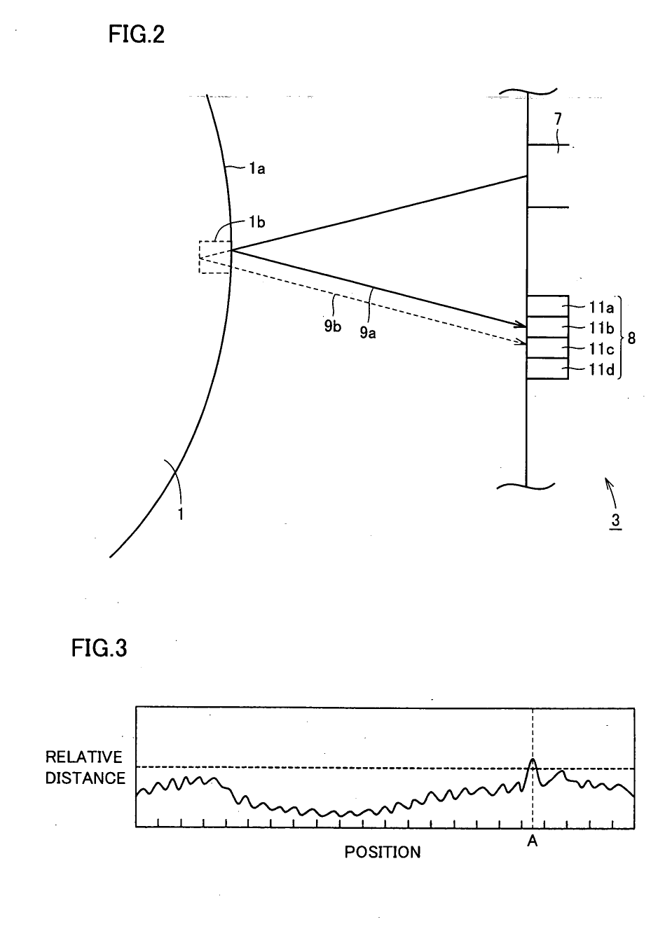

Referring to FIGS. 1 and 2, while semiconductor wafer 1 is rotating, light is projected from light projecting portion 7 of optical displacement sensor 3 on an end part 1a of semiconductor wafer 1. The projected light is reflected from end part 1a, and thus specular reflected light is received by light receiving portion 8 of optical displacement sensor 3. Light receiving portion 8 has a plurality of light receiving elements 11a-11d.

Here, the quantities of specular reflected light received by a plurality of light receiving elements 11a-11d, respectively, (the distribution of the quantity of light in the light receiving portion) change based on a change in the distance from optical displacement sensor 3 to end part 1a, i.e., the presence/absence of a defect in end part 1a. Specifically, when a defect is absent in end part 1a, light 9a reflected from end part 1a is mainly received by, for example, light receiving element 11b. Therefore, the quantity of specular reflected light attains a distribution where the quantity of light received by light receiving element 11b is the greatest. On the other hand, when a defect 1b is present in end part 1a, light 9b reflected from the bottom of defect 1b is mainly received by, for example, light receiving element 11c. Therefore, the distribution of the quantity of specular reflected light changes to a distribution where the quantity of light received by light receiving element 11c is the greatest. It is noted that, though light receiving portion 8 also receives scattering reflected light, the quantity thereof is very small. Therefore, it does not affect the accuracy of device for examining an end part 10.

The distribution data of the quantity of specular reflected light received by light receiving portion 8 is transmitted to displacement sensor amplifier 4. In displacement sensor amplifier 4, the relative distance from optical displacement sensor 3 to end part 1a over the entire periphery of semiconductor wafer 1 is calculated, based on the distribution data of the quantity of specular reflected light.

Referring to FIG. 3, when a defect is in end part 1a, for example, in position A, the relative distance from optical displacement sensor 3 to end part 1a becomes great in position A.

Referring to FIG. 1, data of the relative distance calculated by displacement sensor amplifier 4 is transmitted to data processing apparatus 5. In data processing apparatus 5, for example the following calculation process flow is performed, whereby a defect in end part 1a of semiconductor wafer 1 is evaluated.

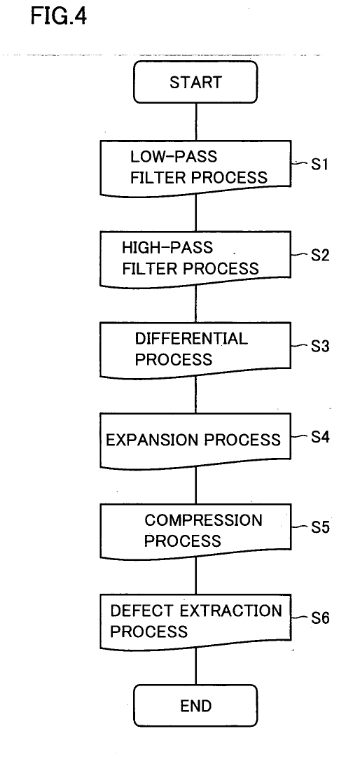

Referring to FIG. 4, first a low-pass filter process is performed (step S1). Thus, when waviness is present around semiconductor wafer 1, the waviness components in the data are removed. Next, a high-pass filter process is performed (step S2). Thus, the noise components in the data are removed. Next, a differential process is performed (step S3). Thus, the absolute value of the change components in the data is extracted, and the displacement amount of end part 1a of semiconductor wafer 1 is calculated. Next, an expansion process is performed (step S4). Specifically, the value of the change components is raised to the second or the third power. Thus, the magnitude of the change components of the data is emphasized. Next, a compression process is performed (step S5). Thus, the data, in which the magnitude of the change components is emphasized, is displayed within an appropriate scale. When an examination is conducted for a defect with a threshold value, the threshold value, the data, and the scale are adjusted. Next, a defect extraction process is performed (step S6). Thus, a portion with a displacement exceeding the threshold value is evaluated as a defect.

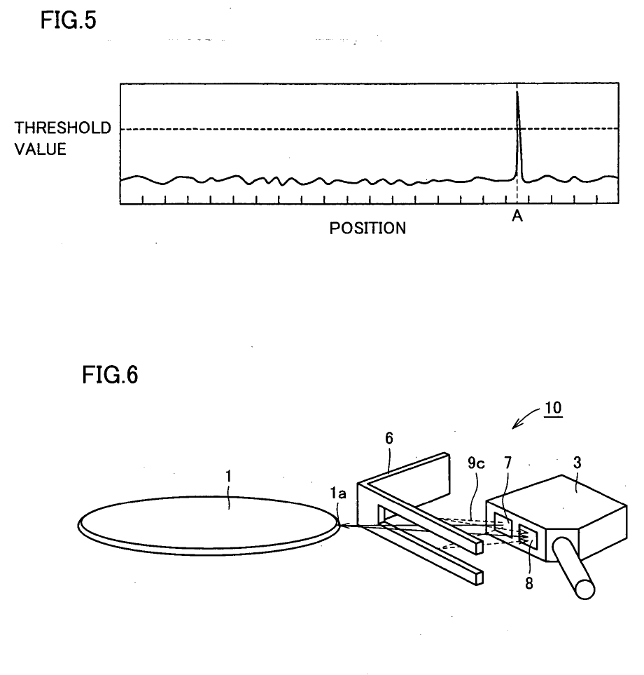

Referring to FIG. 5, the displacement amount in position A exceeds the threshold value. From the data, it is determined that a defect is present in position A.

In device for examining an end part 10 according to the present embodiment, the displacement amount of end part 1a of semiconductor wafer 1 is calculated based on a change in a distribution of a quantity of the specular reflected light received by the light receiving portion 9. The specular reflected light is the light reflected from semiconductor wafer 1 in a constant direction. Accordingly, the configuration for receiving light requires only one light receiving portion 8. Therefore, a configuration such as an ellipsoidal mirror is not necessary, and a plurality of light receiving portions are not necessary. Therefore, the device for examining an end part 10 can be reduced in size and simplified. It is noted that, since in the present embodiment the calculation process flow shown in FIG. 4 is performed by software, electric circuitry for performing low-pass filter process or the like is not necessary. Therefore, device for examining an end part 10 can further be reduced in size and simplified.

Additionally, with a change of the material of the end part 1a of semiconductor wafer 1, the distribution of the quantity of received specular reflected light changes only slightly as compared to scattering reflected light. Accordingly, the change of the material of end part 1a of semiconductor wafer 1 is hardly detected as a defect falsely.

It should be noted that, while the present embodiment has been described with reference to a case where an examination for a defect in end part 1a of semiconductor wafer 1 is conducted, the present invention is not limited to such a case and it is applicable as a device for examining an end part of any object.

Further, while the present embodiment has been described with reference to a case where specular reflected light is incident on a part of the light receiving portion, the present invention is also applicable to other cases, for example where specular reflected light has a width broader than the light receiving portion and hence the light is incident on the entire light receiving portion 8.

Still further, while the present embodiment has been described with reference to a case where the data processing shown in FIG. 4 is performed, the present invention is not limited to such a case, and it is only required that the displacement amount of an end part of a measurement target is calculated by a calculating apparatus.

Still further, while the present embodiment has been described with reference to a case where a threshold value is set for determining the position of a defect, the present invention is not limited to such a case. For example, positions with greater displacement amount may be extracted in arbitrary numbers, and the positions may be imaged by a CCD camera or the like. Then, based on the image, an examination may be conducted for defects, and positions of the defects may be determined.

### Second Embodiment

Referring to FIG. 6, device for examining an end part 10 according to the present embodiment further includes a slit (a reflective member) 6. Light is projected from light projecting portion 7 of optical displacement sensor 3 on and around end part 1a of semiconductor wafer 1. In the light, the light 9c projected around end part 1a is reflected from slit 6 and received by light receiving portion 8. Preferably, slit 6 has a width whereby about 10% of total quantity of light projected from light projecting portion 7 is reflected. Additionally, the light reflecting portion of slit 6 has preferably a width of at least 1-2 mm, for example.

The rest of the configuration is substantially the same as that of the first embodiment shown in FIGS. 1-5, and therefore the identical members are denoted by the identical reference characters, and the description thereof will not be repeated.

Semiconductor wafer 1 to be examined is of various types, and the shape of end part 1a of semiconductor wafer 1 is various as well. When end part 1a of different type of semiconductor wafer 1 is examined, the shape of end part 1a of different type of semiconductor wafers 1 differs as well. As the quantity and the direction of scattering reflected light largely change with different shape of end part 1a of semiconductor wafer 1, a conventional device for examining an end part requires to be adjusted so as to address the shape of end part 1a of semiconductor wafer 1. This has been resulted in the complication of the device operation and an increase in the examination time.

On the other hand, according to the present embodiment, specular reflected light from semiconductor wafer 1 and reflected light from slit 6 are received, and based on a change in a distribution of a quantity of the specular reflected light, an displacement amount of end part 1a of semiconductor wafer 1 is calculated.

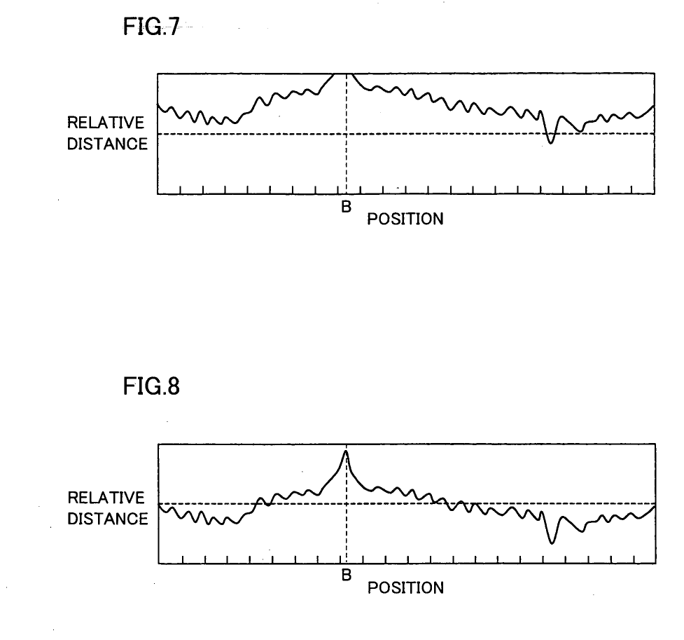

Here, when slit 6 is not included in the present embodiment, with different shape of end part 1a of semiconductor wafer 1, the distribution of a quantity of the specular reflected light largely changes and therefore the quantity of the specular reflected light received by light receiving portion 8 tends to decrease. Referring to FIG. 7, the quantity of the specular reflected light received by light receiving portion 8 is decreased, and in position B, it is calculated as a relative distance that exceeds the measurement limit of light receiving portion 8. In such a case, a defect in position B cannot be detected.

Referring to FIG. 8, in device for examining an end part 10 according to the present embodiment, the decrease in the quantity of the specular reflected light received by light receiving portion 8 is supplemented by reflected light from slit 6. Thus, as the relative distance is calculated within a range of measurement limit also in position B, a defect in position B can be detected.

In device for examining an end part 10 according to the present embodiment, specular reflected light from semiconductor wafer 1 and reflected light from slit 6 are received by light receiving portion 8, and a displacement amount of end part 1a of semiconductor wafer 1 is calculated based on a change in a distribution of the quantity of the specular reflected light. Thus, even with different shape of end part 1a of semiconductor wafer 1, by which the quantity of specular reflected light from semiconductor wafer 1 decreases, the quantity of light is supplemented by the reflected light from slit 6. Accordingly, the quantity of light is prevented from decreasing below the measurement limit of the quantity of light received by light receiving portion 8. Also, it is no more necessary to adjust device for examining an end part 10 so as to address the shape of end part 1a of semiconductor wafer 1. Accordingly, the device operation is simplified and the examination time is reduced.

### Third Embodiment

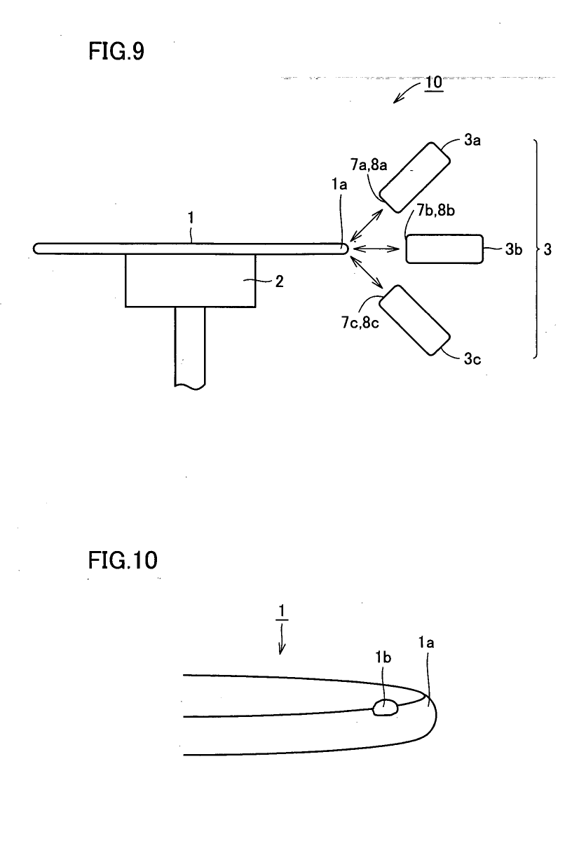

Referring to FIG. 9, device for examining an end part 10 according to the present embodiment further includes three optical displacement sensors 3a-3c. Three optical sensors 3a-3c include light projecting portions 7a-7c and light receiving portions 8a-8c, respectively. Thus, a displacement amount for each of three positions different in the thickness direction of an end part 1a of semiconductor wafer 1 can be measured.

Specifically, optical displacement sensor 3b is arranged in a direction horizontal to the main surface of semiconductor wafer 1. Light projected from light projecting portion 7b (a light projecting portion) of optical displacement sensor 3b is projected on a central portion (a first position) of end part 1a of semiconductor wafer 1. Specular reflected light reflected from the central portion of end part 1a is received by light receiving portion 8b (a light receiving portion).

Optical displacement sensor 3a is arranged at higher position than semiconductor wafer 1. The light projected from light projecting portion 7a (other light projecting portion) of optical displacement sensor 3a is projected on the upper portion (a second position) of end part 1a of semiconductor wafer 1 at an angle of about 20°-40° relative to a plane that is horizontal to the main surface of semiconductor wafer 1. Specular reflected light reflected from the upper portion of end part 1a is received by light receiving portion 8a.

Optical displacement sensor 3c is arranged at lower position than semiconductor wafer 1. The light projected from light projecting portion 7c of optical displacement sensor 3c is projected on the lower portion of end part 1a of semiconductor wafer 1 at an angle of about 20°-40° relative to a plane that is horizontal to the main surface of semiconductor wafer 1. Specular reflected light reflected from the lower portion of end part 1a is received by light receiving portion 8c.

The rest of the configuration is substantially the same as that of the first embodiment shown in FIGS. 1-5, and therefore the identical members are denoted by the identical reference characters, and the description thereof will not be repeated.

Referring to FIG. 10, a defect may occur in the portions of end part 1a of semiconductor wafer 1 other than the central portion, such as in the upper portion or in the lower portion. In optical displacement sensor 3b, a change in a distribution of a quantity of specular reflected light affected by a defect occurring in the upper or lower portion of end part 1a is very small. As such, a configuration having optical displacement sensor 3b only hardly detects a defect occurring in the upper or lower portion of end part 1a.

According to device for examining an end part 10 of the present embodiment, by optical displacement sensors 3a-3c, a change in a distribution of a quantity of specular reflected light is measured for each area of upper, central, and lower portions of end part 1a of semiconductor wafer 1. This enables to conduct an examination for not only a defect in the central portion of end part 1a, but also in upper and lower portions of end part 1a. Accordingly, a defect can be detected in a broader range of end part 1a of semiconductor wafer 1.

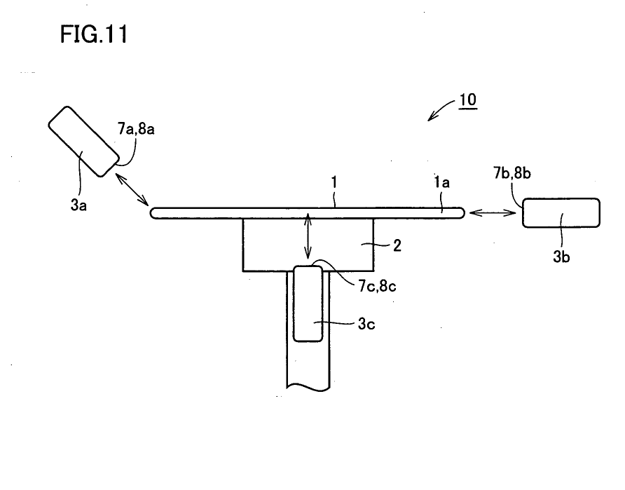

The present embodiment has been described with reference to a case where three optical displacement sensors 3a-3c are arranged at the same position in a circumferential direction of semiconductor wafer 1 but at different positions in the thickness direction. However, the present invention is also applicable to other cases, for example, as shown in FIG. 11, where three optical displacement sensors 3a-3c are arranged at three different positions in the circumferential direction of semiconductor wafer 1. In this case, as measuring positions of optical displacement sensors 3a-3c are different from one another, compensation of measuring positions of optical displacement sensors 3a-3c is required in determining the position of a defect. Additionally, for avoiding interference among optical displacement sensors 3a-3c, control of light projection timing of light projecting portions 7a-7c and light receiving timing of light receiving portions 8a-8c is required.

While the present embodiment has been described with reference to a case where three optical displacement sensors 3a-3c are arranged, the present invention is not limited to such a configuration, and it is only necessary to include other light projecting portion and other light receiving portion for measuring a displacement amount of the second position. Specifically, for semiconductor wafer 1 with a thickness of at most 250 μm, the configuration shown in FIG. 9 may include only two optical displacement sensors 3a and 3c.

Although the present invention has been described and illustrated in detail, it is clearly understood that the same is by way of illustration and example only and is not to be taken by way of limitation, the spirit and scope of the present invention being limited only by the terms of the appended claims.

1. A device for examining an end part, comprising:
a light projecting portion projecting light on an end part of a measurement target;
a light receiving portion receiving specular reflected light reflected from said end part of the measurement target; and
a calculating apparatus calculating a displacement amount of said end part of the measurement target based on a change in a distribution of a quantity of said specular reflected light received by said light receiving portion.

2. The device for examining an end part according to claim 1, wherein
said light projecting portion projects light on and around said end part of the measurement target, said device for examining an end part further comprising a reflective member reflecting the light projected around said end part of the measurement target to said light receiving portion.

3. The device for examining an end part according to claim 1, wherein
said light projecting portion and said light receiving portion are for measuring a displacement amount of a first position in said end part of the measurement target, said device for examining an end part further comprising other light projecting portion and other light receiving portion for measuring a displacement amount of a second position in said end part of the measurement target, said second position being different from said first position in a thickness direction of said end part of the measurement target.
